(19) United States
(12) Patent Application Publication
(10) Pub. No.: US 2006/0209239 A1
(43) Pub. Date: Sep. 21, 2006

(54) Anti-reflective polarizing plate and uses thereof

(75) Inventor: Chi-Huang Lin, Yongkang City (TW)

Correspondence Address: Min, Hsieh & Hack, LLP;c/o PortfolioIP, P.O. Box 52050, Minneapolis, MN, 55402, US

(73) Assignee: Toppoly Optoelectronics Corporation

(21) Appl. No.: 11/082,949

(22) Filed: Mar. 18, 2005

(51) Int. Cl. G02F 1/1335

(52) U.S. Cl. 349/119

(57) ABSTRACT

There is disclosed a display device including a display panel; a polarizer disposed over one surface of the display panel; and a broadband quarter wave plate disposed between the display panel and the polarizer, wherein the broadband quarter wave plate includes a half wave plate and a quarter wave plate both satisfying a relation Nz=(nx−nz)/(nx−ny)=0.3˜0.8 wherein nx and ny are in-plane main refractive indices and nz is a thickness-wise refractive index.

### FIELD OF THE DISCLOSURE

The present disclosure generally relates to an optical plate and a display device using the same. More particularly, the present disclosure relates to an anti-reflective polarizing plate, a broadband quarter wave plate, a wide viewing angle (WVA) anti-reflective display device and an electronic device using the same.

### BACKGROUND OF THE DISCLOSURE

Display devices generating light include organic electroluminescent (OEL) displays, plasma displays, field emissive displays and the like. Another type of display device transmits or reflects light, such as liquid crystal displays and the like. For both types of display devices, it is important that the displays be bright and exhibit high contrast ratio. The contrast ratio of a display is the ratio of the bright state from the display to the dark state from the display. In all practical environments, the dark state is dominated by reflected light from the ambient light. Reflected light is particularly annoying because the viewer sees a reflected image of the source of the ambient light superimposed on the image and it degrades the image contrast ratio at that specific angle. In addition, reflected light superimposes a haze over the displayed image that reduces contrast ratio and limits the range of viewable gray scale.

FIG. 1 is a sectional view of a display device in which a polarizer and a quarter wave plate are used to resolve the problem of interference of reflected light according to a conventional method. As shown in FIG. 1, a linear polarizer 104 and an uniaxial quarter wave (λ/4) plate 102 are laminated together and disposed over one surface of a display panel 100 having reflective materials therein. The ambient light 106 is polarized when entering the linear polarizer 104, and then the polarized light 106 is circularly polarized when transmitted through the uniaxial quarter wave plate 102. The circularly polarized light 106 is reflected from the reflective materials in the display panel 100 and is reversed. The reflected circularly polarized light 106 is reflected toward the uniaxial quarter wave plate 102 and is absorbed by the linear polarizer 104 so as to avoid the ambient light 106 and to not interfere with useful light emitted from the display panel 100. By this method, ambient green light is anti-reflected efficiently but not for ambient red light and blue light.

FIG. 2 is a sectional view of another conventional display device in which a polarizer plate and a broadband quarter wave plate are used. As shown in FIG. 2, as compared with the display device of FIG. 1, a uniaxial half wave (λ/2) plate 108 is further laminated with the linear polarizer 104 and the uniaxial quarter wave plate 102, wherein the lamination of the half wave plate 108 and the quarter wave plate 102 is also called a broadband quarter wave plate. Although ambient normal white light 106a (red, green, blue light) is anti-reflected efficiently by this method, light 106b obliquely entering the display panel 100 cannot be absorbed completely by the linear polarizer 104. This is because an included angle between the axis of the uniaxial half wave plate 108 and the transmission axis of the linear polarizer 104, and an included angle between the axis of the uniaxial quarter wave plate 102 and the transmission axis of the linear polarizer 104 may change when ambient light incidents into the display device with a different angle. Both the display device of FIG. 1 and the display device of FIG. 2 have poor anti-reflection for oblique light. FIG. 3 is a diagram showing a simulated reflection condition of the display device of FIG. 1. FIG. 4 is a diagram showing a simulated reflection condition of the display device of FIG. 2. As shown in FIG. 3 and FIG. 4, both of the two display devices have poor anti-reflection. In FIG. 3, reflective ratios on the region where the polar angle is of 50 degree and the azimuth angle range of degrees 0, 90, 180 and 270 are lager than 0.01. At the same status in FIG. 4, the reflective ratios are larger than 0.01.

### SUMMARY OF THE DISCLOSURE

According to various embodiments there is provided a display device, comprising a display panel; a polarizer disposed over one surface of the display panel; and a broadband quarter wave plate disposed between the display panel and the polarizer, wherein the broadband quarter wave plate comprises a half wave plate and a quarter wave plate both satisfying a relation Nz=(nx−nz)/(nx−ny)=0.3˜0.8 wherein nx and ny are in-plane main refractive indices and nz is a thickness-wise refractive index.

According to various embodiments there is provided a polarizing plate, comprising a polarizer; and a broadband quarter wave plate disposed over the polarizer, wherein the broadband quarter wave plate comprises a half wave plate and a quarter wave plate both satisfying a relation Nz=(nx−nz)/(nx−ny)=0.3˜0.8 wherein nx and ny are in-plane main refractive indices and nz is a thicknesswise refractive index.

According to various embodiments there is provided a broadband quarter wave plate, comprising a half wave plate and a quarter wave plate laminated together, wherein each of the half wave plate and the quarter wave plate satisfies a relation Nz=(nx−nz)/(nx−ny)=0.3˜0.8 wherein nx and ny are in-plane main refractive indices and nz is a thicknesswise refractive index.

Additional advantages will be set forth in part in the description which follows, and in part will be obvious from the description, or may be learned by practice of the invention. The advantages will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a sectional view of a conventional display device.

FIG. 2 is a sectional view of another conventional display device.

FIG. 3 is a diagram showing a simulated reflection condition of the display device of FIG. 1.

FIG. 4 is a diagram showing a simulated reflection condition of the display device of FIG. 2.

FIG. 5 is a sectional view of a wide viewing angle anti-reflective display device according to an embodiment of the present disclosure.

FIG. 6A is a drawing showing an orientation relationship of the polarizer axis, the quarter wave plate, and the half wave plate of the present disclosure when normally observing the display device according to one embodiment of the present disclosure.

FIG. 6B is a drawing showing an orientation relationship of the polarizer axis, the quarter wave plate, and the half wave plate of the present disclosure when obliquely observing the display device according to one embodiment of the present disclosure.

FIG. 7 is a diagram showing a simulated reflection condition of the display device of FIG. 5.

FIG. 8 is a drawing showing an electronic device according to an embodiment of the present disclosure.

### DESCRIPTION OF THE EMBODIMENTS

Reference will now be made in detail to the disclosed present embodiments (exemplary embodiments), examples of which may be illustrated in the accompanying drawings. Wherever possible, the same reference numbers will be used throughout the drawings to refer to the same or like parts.

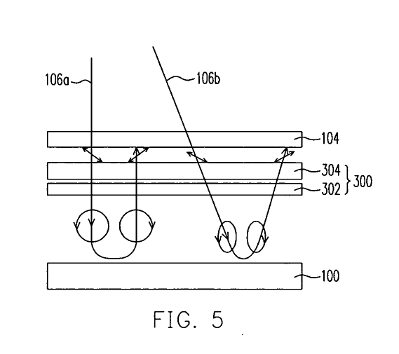

FIG. 5 is a sectional view of a wide viewing angle anti-reflective display device according to an embodiment. As shown in FIG. 5, the wide viewing angle anti-reflective display device comprises at least a display panel 100, a polarizer 104 and a broadband quarter wave plate 300 comprising a quarter wave plate 302 and a half wave plate 304. The polarizer 104 may be disposed over one surface of the display panel 100, and the broadband quarter wave plate 300 may be sandwiched between the polarizer 104 and the display panel 100. In an embodiment, the half wave plate 304 may be sandwiched between the polarizer 104 and the quarter wave plate 302.

The display panel 100 has reflective materials therein, such as metal lines (e.g., date lines, scan lines, etc.), electrodes (e.g., gate electrodes, source/drain electrode, storage capacitors, etc.) or other reflective films (e.g., semiconductor films).

The display panel 100 may be selected from the group consisting of liquid crystal display (LCD) panels, organic electroluminescent (OEL) display panels, plasma display panels, field emissive display panels, and the like.

The polarizer 104 may be a linear polarizer, for example, the quarter wave plate 302 may be a biaxial quarter wave plate, for example, and the half wave plate 304 is a biaxial half wave plate, for example. In particular, the half wave plate 304 and the quarter wave plate 302 may both satisfy a relation Nz=(nx−nz)/(nx−ny)=0.3˜0.8, for example Nz=0.3˜0.6 wherein nx and ny may be in-plane main refractive indices and nz may be a thickness-wise refractive index, wherein nx≠ny≠nz. In an embodiment, the half wave plate 304 and the quarter wave plate 302 may satisfy a relation Nz=(nx−nz)/(nx−ny)=0.5, the display may have, for example, anti-reflective effect and good wide viewing angle.

As shown in FIG. 5, the ambient normal light 106a may be linearly polarized when entering the linear polarizer 104. Then, when the linearly polarized light 106a enters the broadband quarter wave plate 300, the linearly polarized light 106a may be changed to circularly polarized light by the broadband quarter wave plate 300, such as left circularly polarized light, and may be transmitted toward the display panel 100. The left circularly polarized light may be reflected from the reflective material (such as metal lines, electrodes or reflective films) in the display panel 100 and may be reversed as right circularly polarized light. The right circularly polarized light may be reflected toward the broadband quarter wave plate 300 and may be circularly polarized again so as to become a linearly polarized light having an axis approach perpendicular to the transmission axis of the linear polarizer 104. An angle between the axis of linearly polarized light and transmission axis may be, for example, from about 85° to about 90°. Therefore, both the left and right circularly polarized light may be absorbed by the linear polarizer 104 during transmission through and reflection in the display panel 100 so that they do not interfere with emitted light signal from the display panel 100.

The ambient oblique light 106b may also permeate in the same manner as the ambient normal light 106a during transmission through and reflection in the display panel 100. This may be because the half wave plate 304 and the quarter wave plate 302 of the broadband quarter wave plate 300 both satisfy a relation Nz=(nx−nz)/(nx−ny)=0.3˜0.8, for example Nz=0.3˜0.6 (wherein nx≠ny≠nz) so that the axis thereof may be fixed at the same orientation even light obliquely incidents into the display device. The detailed explanation is as below.

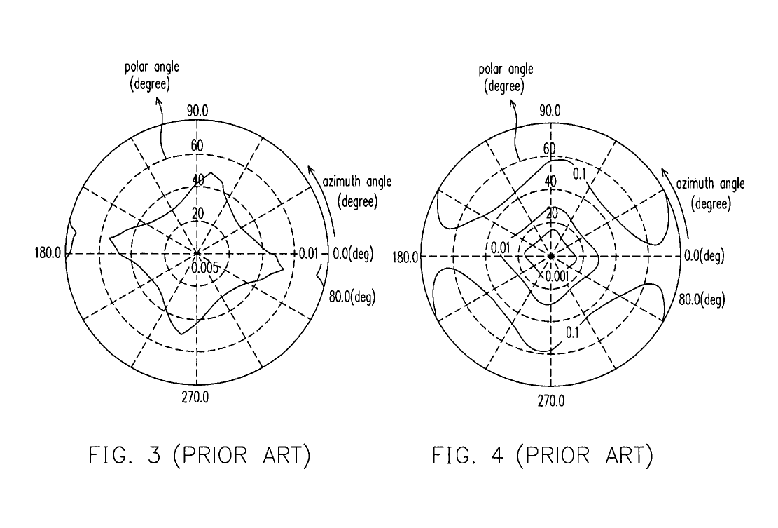

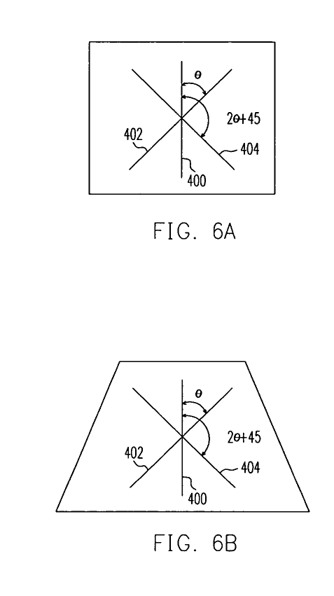

FIG. 6A is a drawing showing an orientation relationship of the polarizer axis the polarizer, the quarter wave plate, and the half wave plate when normally observing the display device according to one embodiment. As shown in FIG. 6A, an included angle θ may exist between the transmission axis 402 of the linear polarizer and the axis 400 of the half wave plate while the transmission axis 402 of the linear polarizer and the axis 404 of the quarter wave plate have an included angle (2θ+45) therebetween so that the ambient normal light may be absorbed efficiently. Hence, the lamination comprising the linear polarizer 104, the quarter wave plate 302 and the half wave plate 304 (as shown in FIG. 3) may have good anti-reflection.

FIG. 6B is a drawing showing an orientation relationship of the polarizer axis, the quarter wave plate and the half wave plate when obliquely observing the display device according to one embodiment. Because the display device may comprise the half wave plate and the quarter wave plate therein both satisfying a relation Nz=(nx−nz)/(nx−ny)=0.3˜0.8, the transmission axis 402 of the linear polarizer and the axis 400 of the half wave plate may comprise an included angle θ therebetween, and the transmission axis 402 of the linear polarizer and the axis 404 of the quarter wave plate may also have an included angle (2θ+45) therebetween, even if ambient light obliquely incidents into the display device.

It should be noted that if the absorption axis of the linear polarizer 104 (as shown in FIG. 5) is substantially parallel to the horizontal direction of the display panel 100, it further has an advantage of good sunglass visibility. Hence, the display device can be used in outdoor environments because it has good anti-reflection and good sunglass visibility.

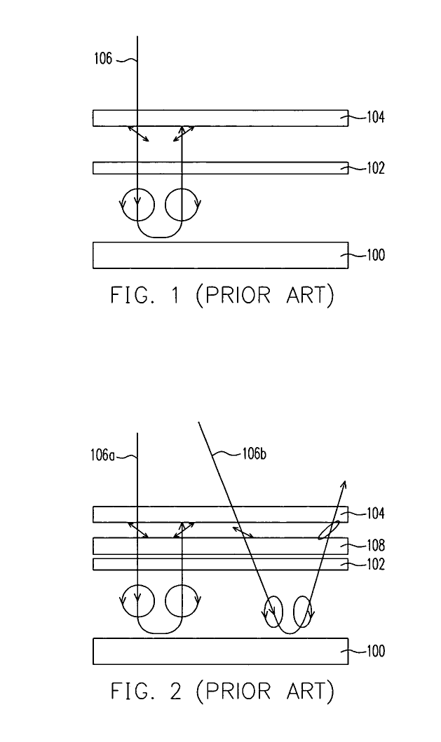

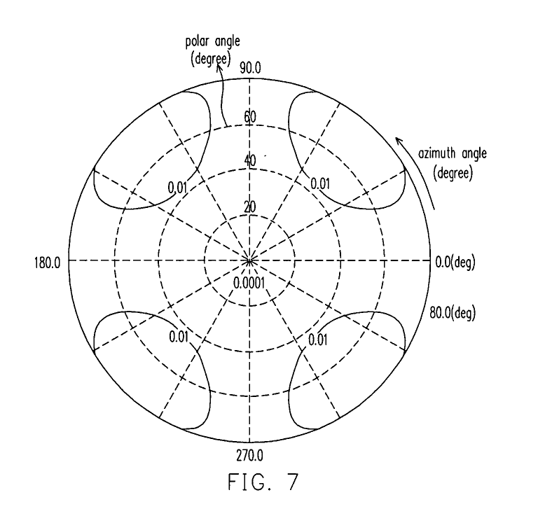

FIG. 7 is a diagram showing a simulated reflection condition of the display device of FIG. 5 according to one embodiment. As shown in FIG. 7, it is noted that reflective ratios on the region where the polar angle is of 80 degree and the azimuth angle range of degrees 0, 90, 180 and 270 are less than 0.01, as compared with the conventional display devices of FIG. 1 and FIG. 2, the disclosed display device may have good anti-reflection, with a maximum of average reflective ratio of about 0.01.

Accordingly, an anti-reflective polarizing plate may comprise a polarizer and a broadband quarter wave plate comprising a half wave plate and a quarter wave plate both satisfying a relation Nz=(nx−nz)/(nx−ny)=0.3˜0.8. The anti-reflective polarizing plate can provide excellent wide-angle anti-reflection so as to be applied to display devices or other devices requiring anti-reflection.

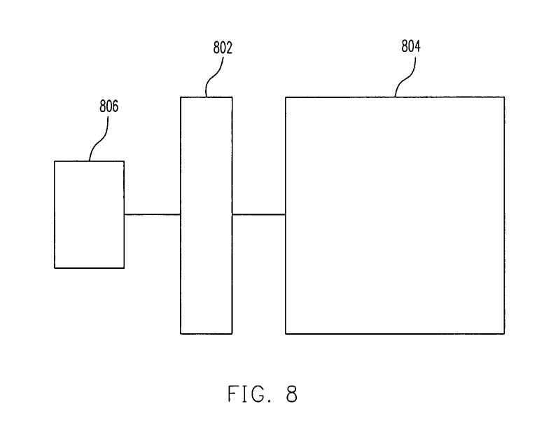

FIG. 8 is a drawing showing an electronic device according to an embodiment. The electronic device may comprise a display device 804, a controller 802 and an input device 806. The display device 804 may be similar to the wide viewing angle anti-reflective display device of FIG. 5 and is omitted herein. The controller 802 may be electrically coupled to the display device 804. The controller 802 may comprise a source and a gate driving circuits (not shown) to control the display device 804 to render image in accordance with an input. The input device 806 may be electrically coupled to the controller 802 and may include a processor or the like to input data to the controller 802 to render an image on the display device 804.

Furthermore, a broadband quarter wave plate may comprise a half wave plate and a quarter wave plate both satisfying a relation Nz=(nx−nz)/(nx−ny)=0.3˜0.8. For the broadband quarter wave plate, its axis orientation may be fixed when light transmits through the broadband quarter wave plate with any angle. It is a new broadband quarter wave plate. If the broadband quarter wave plate is laminated with a linear polarizer, it may have good anti-reflection characteristics.

For the foregoing, the display device and the electronic device of the present invention may comprise a biaxial quarter wave plate and a biaxial half wave plate therein both satisfying a relation Nz=(nx−nz)/(nx−ny)=0.3˜0.8 so that ambient light incidents into the display device with any angle may be efficiently absorbed by the lamination comprising the biaxial quarter wave plate, the biaxial half wave plate, and a linear polarizer. In the other words, the display device and the electronic device of the present invention may have wide-angle anti-reflection characteristics.

In addition, because the display device and the electronic device may have wide-angle anti-reflection characteristics, it may have strong contrast so as to improve displaying quality.

It will be apparent to those skilled in the art that various modifications and variations can be made to the structure of the present disclosure without departing from the scope or spirit of the disclosure. In view of the foregoing, it is intended that the present disclosure cover modifications and variations provided they fall within the scope of the following claims and their equivalents.

What is claimed is:

1. A display device, comprising:
a display panel;
a polarizer disposed over one surface of the display panel; and
a broadband quarter wave plate disposed between the display panel and the polarizer,
wherein the broadband quarter wave plate comprises a half wave plate and a quarter wave plate both satisfying a relation Nz=(nx−nz)/(nx−ny)=0.3˜0.8 wherein nx and ny are in-plane main refractive indices and nz is a thickness-wise refractive index.

2. The display device according to claim 1, wherein nx≠ny≠nz.

3. The display device according to claim 1, wherein the half wave plate and the quarter wave plate satisfy a relation Nz=(nx−nz)/(nx−ny)=0.5.

4. The display device according to claim 1, wherein the display panel is selected from the group consisting of a liquid crystal display panel, an organic electroluminescent display panel, a plasma display panel, and a field emissive display panel.

5. The display device according to claim 1, wherein the polarizer has an absorption axis parallel to a horizontal direction of the display panel.

6. The display device according to claim 1, wherein a transmission axis of the polarizer and an axis of the half wave plate comprise an included angle θ therebetween, and the transmission axis of the polarizer and an axis of the quarter wave plate comprise an included angle (2θ+45) therebetween.

7. The display device according to claim 1, wherein the half wave plate is sandwiched between the polarizer and the quarter wave plate, and the quarter wave plate is sandwiched between the half wave plate and the display panel.

8. A polarizing plate, comprising:
a polarizer; and
a broadband quarter wave plate disposed over the polarizer, p1 wherein the broadband quarter wave plate comprises a half wave plate and a quarter wave plate both satisfying a relation Nz=(nx−nz)/(nx−ny)=0.3˜0.8 wherein nx and ny are in-plane main refractive indices and nz is a thicknesswise refractive index.

9. The polarizing plate according to claim 8, wherein nx≠ny≠nz.

10. The polarizing plate according to claim 8, wherein the half wave plate and the quarter wave plate satisfy a relation Nz=(nx−nz)/(nx−ny)=0.5.

11. The polarizing plate according to claim 8, wherein a transmission axis of the polarizer and an axis of the half wave plate comprise an included angle θ therebetween, and the transmission axis of the polarizer and an axis of the quarter wave plate comprise an included angle (2θ+45) therebetween.

12. A broadband quarter wave plate, comprising:
a half wave plate and a quarter wave plate laminated together, wherein each of the half wave plate and the quarter wave plate satisfies a relation Nz=(nx−nz)/(nx−ny)=0.3˜0.8 wherein nx and ny are in-plane main refractive indices and nz is a thicknesswise refractive index.

13. The broadband quarter wave plate according to claim 12, wherein nx≠ny≠nz.

14. The broadband quarter wave plate according to claim 12, wherein the half wave plate and the quarter wave plate satisfy a relation Nz=(nx−nz)/(nx−ny)=0.5.

15. An electronic device, comprising:
a display device as in claim 1;
a controller electrically coupled to the display device; and
an input device electrically coupled to the controller to render an image on the display device.

16. The electronic device according to claim 15, wherein nx≠ny≠nz.

17. The electronic device according to claim 15, wherein the half wave plate and the quarter wave plate satisfy a relation Nz=(nx−nz)/(nx−ny)=0.5.

18. The electronic device according to claim 15, wherein the polarizer has an absorption axis parallel to the horizontal direction of the display panel.

19. The electronic device according to claim 15, wherein a transmission axis of the polarizer and an axis of the half wave plate comprise an included angle θ therebetween, and the transmission axis of the polarizer and an axis of the quarter wave plate comprise an included angle (2θ+45) therebetween.

20. The electronic device according to claim 15, wherein the half wave plate is sandwiched between the polarizer and the quarter wave plate, and the quarter wave plate is sandwiched between the half wave plate and the display panel.
